(19) United States
(12) Patent Application Publication
(10) Pub. No.: US 2005/0099822 A1
(43) Pub. Date: May 12, 2005

(54) Backlight assembly of liquid crystal display

(76) Inventors: Yun Ho Choi, Yongdungpo-gu (KR); Chang Jong Kim, Chungjoo-si (KR); Young Gun Kim, Chungjoo-si (KR); Sang Gon Lee, Daegu-si (KR); Ung Sang Lee, Chungjoo-si (KR)

Correspondence Address: MCKENNA LONG & ALDRIDGE LLP;Song K. Jung, 1900 K Street, N.W., Washington, DC, 20006, US

(21) Appl. No.: 10/949,223

(22) Filed: Sep. 27, 2004

(30) Foreign Application Priority Data
Nov. 12, 2003 (KR) 2003-79739

(51) Int. Cl. F21V 7/04

(52) U.S. Cl. 362/561

(57) ABSTRACT

A backlight assembly of a liquid crystal display is provided. The backlight assembly of a liquid crystal display include a lamp for generating light; a light guide plate disposed at a side of the lamp to guide the light; a diffusion sheet disposed on the light guide plate to scatter the light that is incident from the light guide plate, thereby making brightness distribution of light uniform; and a prism sheet including a body part into which a light diffused from the diffusion sheet is introduced and a plurality of protrusion parts arranged in a specific direction, in which each protrusion part is shaped in a scalene triangle prism form and has both base angles different from each other.

This application claims the benefit of Korean Patent Application No. 2003-79739, filed in Korea on Nov. 12, 2003, which is hereby incorporated by reference for all purposes as if fully set forth herein.

### BACKGROUND OF THE INVENTION

1. Field of the Invention

The present invention relates to a non-luminous flat display device, and more particularly, to an optical sheet of a backlight assembly in a liquid crystal display.

2. Description of the Related Art

Recently, a variety of flat panel displays have been developed to reduce weight and volume acting as drawbacks of cathode ray tubes (CRTs). Such flat panel displays include a liquid crystal display (LCD), a field emission display, a plasma display panel (PDP), an electro-luminescence (EL) and the like. Research for enhancing the display quality and increasing the screen size of the flat panel displays is being actively performed.

Among such flat panel displays, LCDs have several advantages including slimness, light weight, and low power consumption. In particular, the LCD displays information using electrical and optical properties of liquid crystal molecules. The LCD itself is a non-luminous device that displays images using a light source such as a lamp. In other words, unlike the CRT, the LCD essentially needs a separate unit for irradiating light, i.e., a backlight assembly because the liquid crystal molecules injected between a thin film transistor (TFT) substrate and a color filter substrate does not emit light on their own.

In general, a backlight assembly includes a mold frame having a receiving space, a reflector mounted on the lowest surface of the receiving space for reflecting light toward liquid crystal display panel, a light guide plate disposed on the reflector for guiding light, a lamp unit disposed between the light guide plate and a sidewall of the receiving space for emitting light, optical sheets stacked on the light guide plate for diffusing and focusing light, and a top chassis disposed on the mold frame and enclosing the liquid crystal display from a predetermined portion of the edge of the liquid crystal display panel to a side portion of the mold frame.

The optical sheets include a diffusion sheet for diffusing light, a prism sheet disposed on the diffusion sheet for focusing the diffused light and transferring the focused light to the liquid crystal display panel, and a protection sheet for protecting the diffusion sheet and the prism sheet.

FIG. 1 is a sectional view of a related art LCD.

Referring to FIG. 1, the related art LCD includes a backlight assembly 50 for generating light, and a display unit 40, which receives the light from the backlight assembly 50 and displays images. The backlight assembly 50 includes a lamp unit 51 for generating light and a light guide unit for guiding the light generated by the lamp unit 51 toward a liquid crystal display panel 10.

The display unit 40 includes the liquid crystal display panel 10, and an upper polarizer 30 and a lower polarizer 20 respectively disposed on an upper surface and a lower surface of the liquid crystal display panel 10. The liquid crystal display panel 10 includes a TFT substrate 11 and a color filter substrate 12 each having an electrode formed thereon.

Specifically, the lamp unit 51 includes a lamp 51a for generating light and a lamp reflector 51b enclosing the lamp 51a. The light generated by the lamp 51a is incident into a light guide plate 52 to be described later. The lamp reflector 51b reflects the light generated by the lamp 51a toward the light guide plate 52, thereby increasing amount of incident light toward the light guide plate 52.

The light guide unit includes a reflection plate 54, the light guide plate 52, and optical sheets 53. The light guide plate 52 is disposed at one end of the lamp unit 51 to guide the light emitted from the lamp unit 51 such that the light emitted from the lamp unit 51 is incident into the LCD panel 10.

The reflection plate 54 is disposed beneath the light guide plate 52 and reflects light leaked from the light guide plate 52 toward the light guide plate 52 again.

The plurality of optical sheets 53 are disposed on the light guide plate 52 to enhance efficiency of the light passing through the light guide plate 52. Specifically, the optical sheets 53 include a diffusion sheet 53a, a prism sheet 53b and a protection sheet 53c, and are orderly stacked on the light guide plate 52.

The diffusion sheet 53a scatters the light that is incident from the light guide plate 52, thereby making the brightness distribution of the light uniform. The prism sheet 53b includes a plurality of prisms formed repeatedly on an upper surface thereof and focuses the light diffused by the diffusion sheet 53a in a direction perpendicular to a plane of the LCD panel 10. Accordingly, the light that has passed through the prism sheet 53b mostly advances in a direction perpendicular to the plane of the LCD panel 10, thereby obtaining a uniform distribution.

The protection sheet 53c provided on the prism sheet 53b functions not only to protect the upper surface of the prism sheet 53b, but also to diffuse light so as to make the distribution of the light that is incident from the prism sheet 53b uniform.

FIGS. 2A and 2B are a sectional view and a perspective view of the prism sheet illustrated in FIG. 1 respectively.

Referring to FIGS. 2A and 2B, the related art prism sheet 200 includes a body part 210, through which the light diffused by the light guide plate and the diffusion sheet is initially introduced, and a protrusion part 220 shaped in a isosceles triangle prism, for maintaining path of the diffused light constantly. The protrusion part 220 has a plurality of isosceles triangle prisms linearly arranged in a stripe form.

In the protrusion part 220, both base angles of the isosceles triangle prism are 45° and the light is diffused through the protrusion part 220 by the light guide plate and the diffusion sheet, thereby causing straightness of light and enhancing the brightness.

However, in case of such a structure, it is difficult to secure the viewing angle.

In the related art backlight assembly, the prism sheet is formed of ductile material. Therefore, a protection sheet must be provided on the prism sheet in order to protect the surface of the prism sheet.

In this case, some of light that is focused by the prism sheet is diffused by the protection sheet. Also, the light that is diffused by the protection sheet is incident into the liquid crystal panel and passes through liquid crystals. Therefore, a display characteristic of the LCD is degraded.

A compensation film having discotic layer may be further provided for enhancing the display characteristic of the LCD, such as the viewing angle. Even when such a compensation film is used, gray scale inversion is not improved, so that brightness decreases if a voltage increases.

Further, because of the protection sheet and/or the compensation film, the LCD is thicker as a whole, which contravenes the recent trends of lightweight, slimness, etc.

### SUMMARY OF THE INVENTION

Accordingly, the present invention is directed to a liquid crystal display that substantially obviates one or more problems due to limitations and disadvantages of the related art.

An advantage of the present invention is to provide a backlight assembly of a liquid crystal display that is capable of simplifying a construction, securing a wide viewing angle and minimizing degradation of brightness. The backlight assembly includes a prism sheet. The prism sheet includes a protrusion part shaped in a triangle prism form. Both base angles of the protrusion part are different from each other and the prism sheet is formed of thermosetting polymer or ultraviolet hardening polymer and has a hardness equal to or more than a pencil hardness of 2H.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

The objectives and other advantage of the invention may be realized and attained by the structure particularly pointed out in the written description and claims hereof as well as the appended drawings.

To achieve these and other advantages and in accordance with the purpose of the invention, as embodied and broadly described herein, there is provided a backlight assembly of a liquid crystal display, comprising: a lamp for generating light; a light guide plate disposed at a side of the lamp to guide the light; a diffusion sheet disposed on the light guide plate to enhance an efficiency of the light that is emitted from the light guide plate, and a prism sheet, wherein the prism sheet comprises: a body part into which a light diffused from the diffusion sheet is introduced; and a plurality of protrusion parts each being shaped in a scalene triangle prism form, each protrusion having both base angles different from each other, the plurality of protrusion parts being linearly arranged on the body part.

The both base angles of the protrusion part are selected to have a specific value for adjusting a viewing angle of the liquid crystal display. The both base angles of the protrusion part ranges from 10° to 44° or 46° to 89°. A difference between the both base angles of the protrusion part is below 10°.

Also, the body part and the protrusion parts are integrally formed of thermosetting polymer or ultraviolet hardening polymer. The prism sheet has a hardness equal to or more than a pencil hardness of 2H.

Two prism sheets may be provided and angles between protrusion parts of the respective prism sheets are between 0° and 90°.

According to another embodiment of the present invention, there is provided a backlight assembly of a liquid crystal display, comprising: a lamp for generating light; a light guide plate disposed at a side of the lamp to guide the light; a diffusion sheet disposed on the light guide plate to scatter the light that is incident from the light guide plate, thereby making brightness distribution of light uniform; and a prism sheet including: a body part into which a light diffused from the diffusion sheet is introduced; and a plurality of protrusion parts arranged in a specific direction, each protrusion part being shaped in a scalene triangle prism form, each protrusion part having both base angles different from each other.

The both base angles of the protrusion part are selected to have a specific value for adjusting a viewing angle of the liquid crystal display. The specific direction of the protrusion parts is one of a vertical direction and a horizontal direction. The both base angles of the protrusion part ranges from 10° to 44° or 46° to 89°. A difference between the both base angles of the protrusion part is below 10° C.

The body part and the protrusion parts are integrally formed of thermosetting polymer or ultraviolet hardening polymer. The prism sheet has a hardness equal to or more than a pencil hardness of 2H.

Two prism sheets may be provided and angles between protrusion parts of the respective prism sheets being between 0° and 90°.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view showing a construction of a related art LCD;

FIGS. 2A and 2B are a sectional view and a perspective view of the prism sheet illustrated in FIG. 1, respectively;

FIG. 3 is a sectional view illustrating a construction of a backlight assembly of an LCD according to the present invention;

FIG. 4 is a perspective view of a backlight assembly of an LCD according to an embodiment of the present invention;

FIGS. 5A and 5B are a sectional view and a perspective view of the prism sheet illustrated in FIGS. 3 and 4, respectively; and

FIG. 6 is a sectional view of the prism sheet according to an embodiment of the present invention.

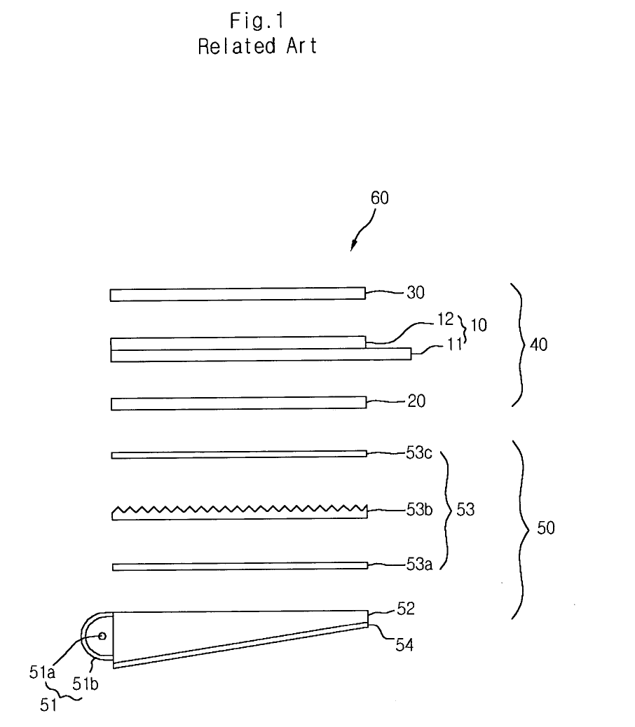

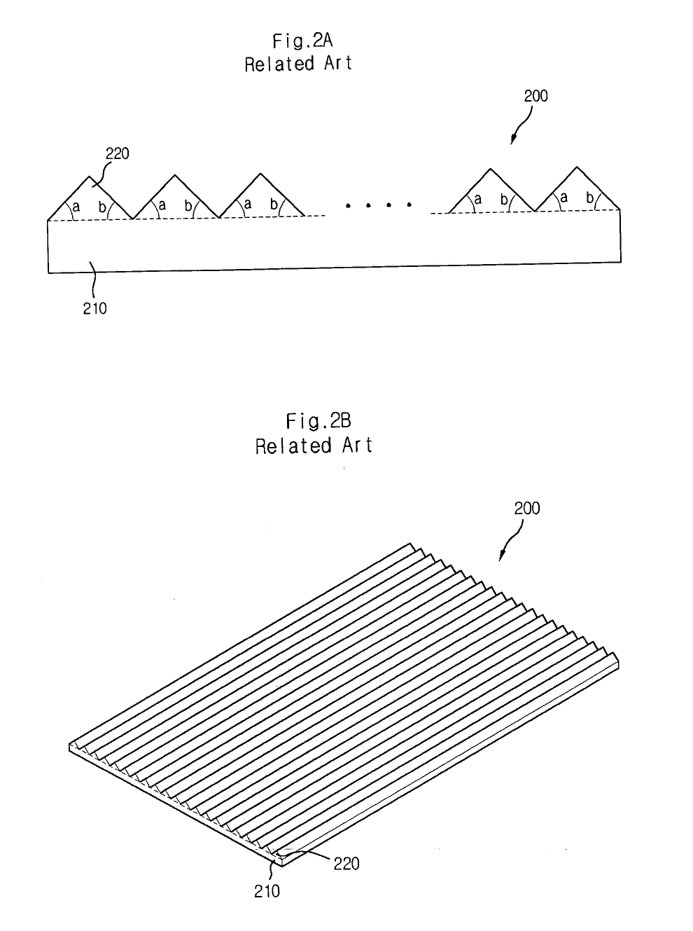

### DETAILED DESCRIPTION OF THE ILLUSTRATED EMBODIMENT

Reference will now be made in detail to embodiments of the present invention, examples of which are illustrated in the accompanying drawings. Wherever possible, the same reference numbers will be used throughout the drawings to refer to the same or like parts.

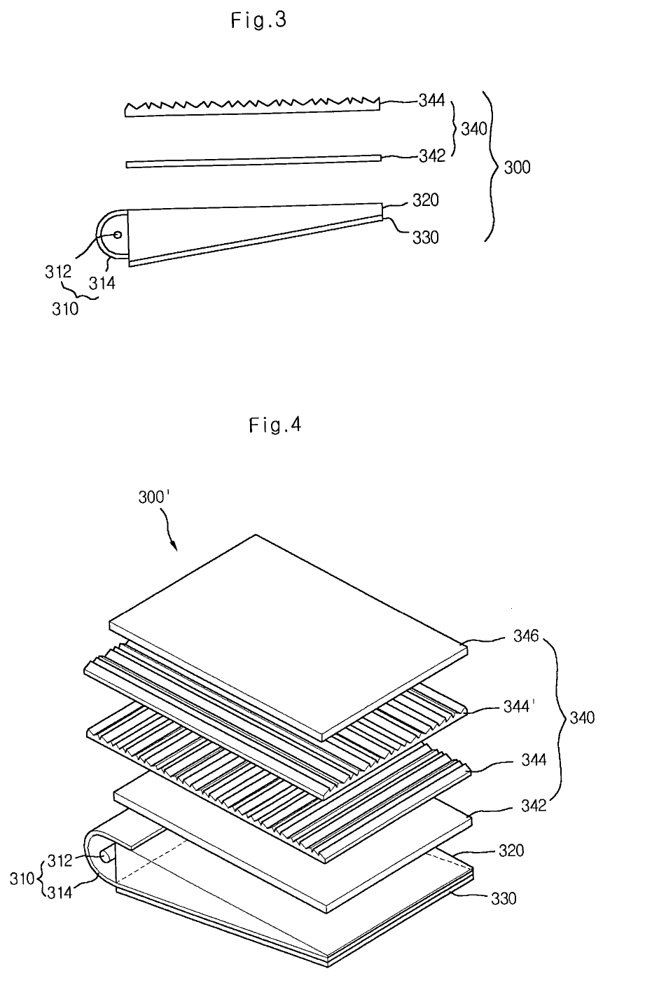

FIG. 3 is a sectional view illustrating a construction of a backlight assembly of an LCD according to the present invention. Referring to FIG. 3, a backlight assembly 300 according to the present invention includes a lamp unit 310 for generating light and a light guide unit for guiding the light toward a liquid crystal panel.

Meanwhile, optical sheets 340 of the light guide unit according to the present invention are provided only with a diffusion sheet 342 and a prism sheet 344, because a protection sheet is removed. The prism sheet 344 includes a plurality of protrusion parts shaped in a triangle prism form, in which the triangle prisms have a scalene triangle cross-section or in which the triangle formed by the cross section of a protrusion part has at least two unequal angles formed between the sides of the triangle a base section. Adjacent ones of the plurality of protrusion parts need not have the same cross section. The prism sheet 344 is formed of thermosetting polymer or ultraviolet hardening polymer and has a hardness equal to or more than pencil hardness of 2H.

In the backlight assembly 300 of the present invention, the lamp unit 310 includes a lamp 312 for generating light and a lamp reflector 314 enclosing the lamp 312. The light that is generated from the lamp 312 is incident into the light guide plate 320. The lamp reflector 314 reflects the light toward the light guide plate 320, thereby increasing an amount of light that is incident into the light guide plate 320. Such a construction is equal to that of a general lamp unit.

The light guide unit includes a reflection plate 330, a light guide plate 320, and an optical sheet 340. The light guide plate 320 is disposed at one end of or adjacent to the lamp unit 310 and guides the light that is generated from the lamp unit 310. At this point, the light guide plate 320 changes light path emitted from the lamp unit toward the liquid crystal panel.

The reflection plate 330 may be disposed beneath the light guide plate 320 to reflect light leaked from the light guide plate 320 toward the light guide plate 320 again.

Meanwhile, the optical sheet is disposed on the light guide plate 320 to enhance efficiency of light that is emitted from the light guide plate 320. The optical sheet 340 has a stacked structure of the diffusion sheet 342 and the prism sheet 344.

According to the present invention, since the protection sheet is removed, the construction of the backlight assembly is simplified and its fabrication is easy.

Here, the diffusion sheet 342 scatters the light that is incident from the light guide plate 320, thereby making the brightness distribution of the light uniform.

Also, the prism sheet 344 includes a plurality of protrusion parts that are repeatedly formed on a body part in a scalene triangle prism form. The scalene triangle prism form means that base angles (α, β) of the protrusion part are different from each other. For reference, base angles α and β are illustrated in FIG. 5A.

In this embodiment, both base angles (α, β) of the protrusion part ranges from 10° to 44° or from 46° to 89°. A difference between both base angles of the protrusion part is below 10°. Such a structure makes it possible to solve the problem of the related art prism sheet, that is, the narrow viewing angle.

Both base angles (α, β) of the protrusion part are selected in order to adjust the viewing angle of the liquid crystal display. If the protrusion part is arranged in a specific direction, the viewing angle can be widened in the specific direction.

Also, since the prism sheet 344 is formed of thermosetting polymer or ultraviolet hardening polymer and is formed to have a hardness equal to or more than pencil hardness of 2H, an additional protection sheet is unnecessary.

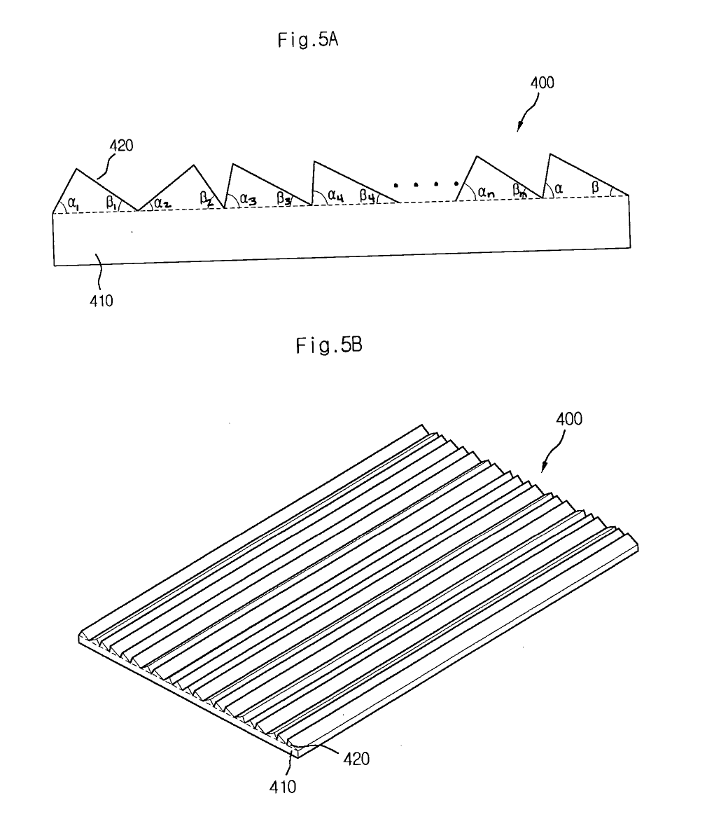

FIG. 4 is a perspective view illustrating a construction of a backlight assembly of an LCD according to an embodiment of the present invention. In FIG. 4, the same reference numbers as those of FIG. 3 are used to refer to the same parts as those of FIG. 3 and their descriptions will be omitted.

Referring to FIG. 4, a basic structure of a backlight assembly 300′ according to an embodiment of the present invention is the same in basic constitution as the backlight assembly 300 of FIG. 3. A difference is that two prism sheets 344 and 344′ are provided and an offset angle between protrusion parts of the prism sheets 344 and 344′ ranges from 0° to 90°.

This is to focus light that is diffused from the diffusion sheet 320 more effectively and enhance the brightness and viewing angle of the liquid crystal panel.

In addition, as described in FIG. 3, the two prism sheets 344 and 344′ include the protrusion parts that are repeatedly formed on the body part in the scalene triangle prism form. At this point, both base angles (α, β) of the protrusion part ranges from 10° to 44° or from 46° to 89°. A difference between both base angles of the protrusion part is below 10°.

In case of the backlight assembly 300′, a protection sheet or compensation sheet 346 may be disposed on the prism sheet. Meanwhile, in case the prism sheets 344 and 344′ are formed of thermosetting polymer or ultraviolet hardening polymer and has a hardness equal to or more than pencil hardness of 2H, the protection sheet or compensation sheet may be removed.

FIGS. 5A and 5B are a sectional view and a perspective view of the prism sheet shown in FIGS. 3 and 4, respectively. Referring to FIGS. 5A and 5B, the prism sheet 400 according to the present invention includes a body part 410 and a plurality of protrusion parts 420. The light that is diffused by the light guide plate and the diffusion sheet is initially introduced into the body part 410. The protrusion parts 420 are substantially triangular having a base portion along the body part 410 and having base angles (α, β) different from each other. The protrusion parts 420 are linearly arranged on the body part 410 in a stripe form. In other words, the protrusion parts 420 are formed in parallel with each other, extending from one end of the body part 410 to the other end.

The protrusion part 420 can be arranged in a specific direction, for example, in a vertical or horizontal direction. If patterns of the protrusion parts are formed in the specific direction, the viewing angle can be widened in the vertical or horizontal direction according to the size of both base angles of the patterns.

At this point, as described above, both base angles (α, β) of the protrusion part ranges from 10° to 44° or from 46° to 89°. A difference between both base angles of the protrusion part is below 10°. This is to minimize degradation in efficiency of light source, which is introduced from the backlight, and to obtain the wide viewing angle.

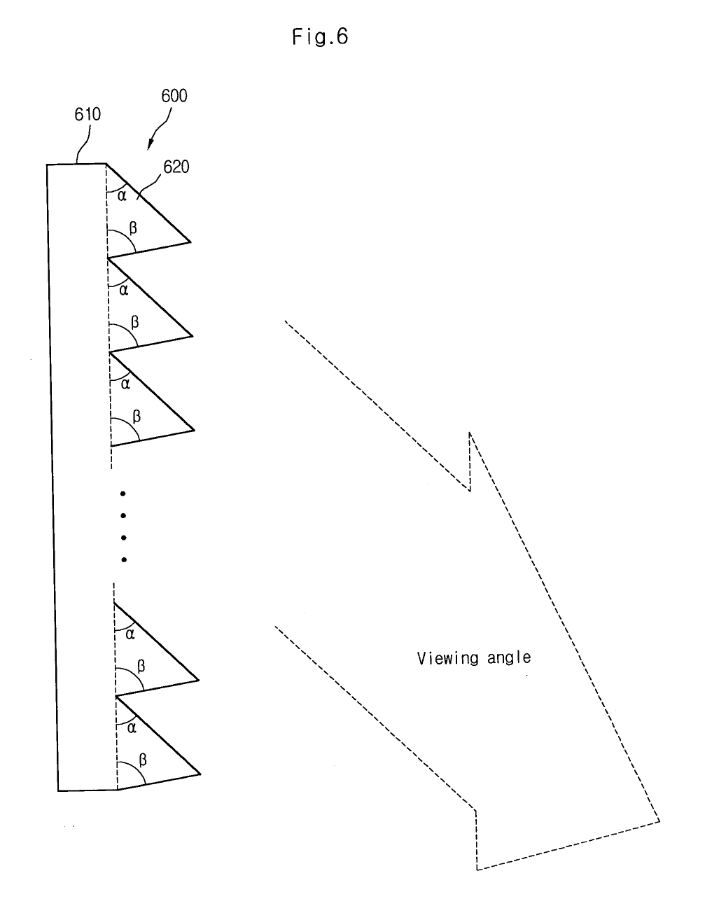

Both base angles (α, β) of the protrusion part are selected in order to adjust the viewing angle of the liquid crystal display. If the protrusion part is arranged in a specific direction, the viewing angle can be widened in the specific direction, which will be described later with reference to FIG. 6.

In addition, it is preferable that the protrusion parts 420 are formed integrally with the body part 410. In other words, the prism sheet 400 is processed to have the protrusion parts 420 on one surface of a flat film.

The prism sheet 400 is formed of thermosetting polymer or ultraviolet hardening polymer and is formed to have hardness equal to or more than pencil hardness of 2H. In this manner, the protection sheet provided at the related art optical sheet can be removed.

FIG. 6 is a sectional view of the prism sheet according to an embodiment of the present invention. In FIG. 6, only the prism sheet of the liquid crystal display is separately shown for explanation of the viewing angle.

If the liquid crystal display is used in an advertising board, the advertising board is mostly installed above a human's view. In this case, if both base angles (α, β) of the protrusion part are adjusted properly so that a plurality of protrusion parts 620 formed on the body part 610 of the prism sheet 600 can be arranged downward, the downward viewing angle of the liquid crystal display is enhanced. Therefore, persons who view the advertising board can easily obtain the viewing angle.

As illustrated in FIG. 6, the viewing angle of a specific direction can be secured by adjusting both base angles of each protrusion part in the prism sheet.

For example, when the backlight assembly of the present invention is used as a billboard, it is most preferable that the viewing angle is kept at a range of 30° to 45° in a downward direction centering on a horizontal plane. For this purpose, it is preferable that one (α) of both base angles forming the protrusion parts 620 of the prism sheet is kept at a range of 46° to 60°.

At this point, the other base angle (β) has a size corresponding to a range that an absolute difference between both base angles, namely, |α−β|, is less than 10°.

In other words, when the base angles α and β of each of the plurality of protrusion parts 620 of the prism sheet 620 are formed at predetermined angles, a viewing angle ranging from 30° to 45° is maintained so that most efficient viewing angles for viewers can be secured.

According to the backlight assembly of the present invention, the construction of the backlight assembly is simplified and its fabrication is easy because the protection sheet among the optical sheets is removed.

Further, degradation in efficiency of the light source can be minimized and the wide viewing angle can be obtained by forming the protrusion parts of the prism sheet to have both base angles different from each other. Furthermore, the viewing angle can be widened in the vertical or horizontal direction by forming the patterns of the protrusion parts in a specific direction.

It will be apparent to those skilled in the art that various modifications and variations can be made in the present invention. Thus, it is intended that the present invention covers the modifications and variations of this invention provided they come within the scope of the appended claims and their equivalents.

1. A backlight assembly of a liquid crystal display, the backlight assembly comprising:
a lamp for generating light;
a light guide plate disposed at a side of the lamp to guide the light;
a diffusion sheet disposed on the light guide plate to enhance an efficiency of the light that is emitted from the light guide plate; and
a prism sheet, wherein the prism sheet comprises:
a body part into which a light diffused from the diffusion sheet is introduced; and
a plurality of protrusion parts each being shaped in a scalene triangle prism form, each protrusion having both base angles different from each other, the plurality of protrusion parts being linearly arranged on the body part.

2. The backlight assembly according to claim 1, wherein the both base angles of the protrusion part are selected to have a specific value for adjusting a viewing angle of the liquid crystal display.

3. The backlight assembly according to claim 2, the both base angles of the protrusion part are selected such that one base angle is kept at a range of 46° to 60° and the other base angle ranges within a size where an absolute difference between the both base angles is less than 10°.

4. The backlight assembly according to claim 1, wherein the both base angles of the protrusion part ranges from 10° to 44° or 46° to 89°.

5. The backlight assembly according to claim 1, wherein a difference between the both base angles of the protrusion part is below 10°.

6. The backlight assembly according to claim 1, wherein the body part and the protrusion parts are integrally formed of thermosetting polymer or ultraviolet hardening polymer.

7. The backlight assembly according to claim 1, wherein the prism sheet has a hardness equal to or more than a pencil hardness of 2H.

8. The backlight assembly according to claim 1, wherein two prism sheets are provided, angles between protrusion parts of the respective prism sheets being between 0° and 90°.

9. A backlight assembly of a liquid crystal display, comprising:
a lamp for generating light;
a light guide plate disposed at a side of the lamp to guide the light;
a diffusion sheet disposed on the light guide plate to scatter the light that is incident from the light guide plate, thereby making brightness distribution of light uniform; and
a prism sheet including:
a body part into which a light diffused from the diffusion sheet is introduced; and
a plurality of protrusion parts arranged in a specific direction, each protrusion part being shaped in a scalene triangle prism form, each protrusion part having both base angles different from each other.

10. The backlight assembly according to claim 9, wherein the both base angles of the protrusion part are selected to have a specific value for adjusting a viewing angle of the liquid crystal display.

11. The backlight assembly according to claim 10, the both base angles of the protrusion part are selected such that one base angle is kept at a range of 46° to 60° and the other base angle ranges within a size where an absolute difference between the both base angles is less than 10°.

12. The backlight assembly according to claim 9, wherein the specific direction of the protrusion parts is one of a vertical direction and a horizontal direction.

13. The backlight assembly according to claim 9, wherein the both base angles of the protrusion part ranges from 10° to 44° or 46° to 89°.

14. The backlight assembly according to claim 9, wherein a difference between the both base angles of the protrusion part is below 10° C.

15. The backlight assembly according to claim 9, wherein he body part and the protrusion parts are integrally formed of thermosetting polymer or ultraviolet hardening polymer.

16. The backlight assembly according to claim 9, wherein the prism sheet has a hardness equal to or more than a pencil hardness of 2H.

17. The backlight assembly according to claim 9, wherein two prism sheets are provided, angles between protrusion parts of the respective prism sheets being between 0° and 90°.

18. A backlight assembly of a liquid crystal display, the backlight assembly comprising:
a lamp for generating light;
a light guide plate disposed adjacent the lamp to guide the light;
a diffusion sheet disposed on the light guide plate, and a prism sheet, wherein the prism sheet comprises:
a body part into which a light diffused from the diffusion sheet is introduced; and
a plurality of protrusion parts substantially linearly arranged on the body part, each being substantially triangular and having respective base angles between the body part and a side of the respective protrusion part different from each other.

19. The backlight assembly according to claim 18, wherein the both base angles of the protrusion part are selected to have a specific value for adjusting a viewing angle of the liquid crystal display.

20. The backlight assembly according to claim 19, the base angles of the protrusion parts are selected such that one base angle is kept at a range of 46° to 60° and the other base angle ranges within a size where an absolute difference between the both base angles is less than 10°.

21. The backlight assembly according to claim 18, wherein the base angles of the protrusion part range from 10° to 44° or 46° to 89°.

22. The backlight assembly according to claim 18, wherein a difference between the base angles of the protrusion part is below 10°.

23. The backlight assembly according to claim 18, wherein the body part and the protrusion parts are integrally formed of thermosetting polymer or ultraviolet hardening polymer.

24. The backlight assembly according to claim 18, wherein the prism sheet has a hardness equal to or more than a pencil hardness of 2H.

25. The backlight assembly according to claim 18, wherein two prism sheets are provided, angles between protrusion parts of the respective prism sheets being between 0° and 90°.

26. The backlight assembly of claim 18, wherein the plurality of protrusion parts include a first protrusion part with base angels α, and β₁, where α₁≠β₁, and a second protrusion part with base angels α₂, and β₂, where α₂≠β₂ and wherein α₁≠α₂ and β₁≈β₂.
